(19) United States
(12) Patent Application Publication
(10) Pub. No.: US 2014/0070473 A1
(43) Pub. Date: Mar. 13, 2014

(54) MACHINING METHOD AND APPARATUS CAPABLE OF CONTINUOUS MACHINING

(71) Applicant: Yu-Pei HO, Taichung City (TW)

(72) Inventor: Yu-Pei HO, Taichung City (TW)

(73) Assignee: EVERINN INTERNATIONAL CO., LTD.

(21) Appl. No.: 13/611,356

(22) Filed: Sep. 12, 2012

(51) Int. Cl. B23Q 1/64

(52) U.S. Cl. 269/56; 29/559

(57) ABSTRACT

In a machining method and apparatus, a machining station is disposed spacedly between first and second material-feeding stations. A slider for being mounted with target first and second workpieces fed respectively from the first and second material-feeding stations thereon is movable between a first position, where the machining station machines the target second workpiece, and simultaneously, a next first workpiece fed from the first material-feeding station is mounted on the slider as the target first workpiece, and a second position, where the machining station machines the target first workpiece, and simultaneously, a next second workpiece fed from the second material-feeding station is mounted on the slider as the target second workpiece.

### BACKGROUND OF THE INVENTION

1. Field of the Invention

The invention relates to a machining method and apparatus, and more particularly to a machining method and apparatus capable of continuous machining.

2. Description of the Related Art

With the development of industrial science and technology, obtainment of optimum production efficiency and maximum benefit under limited equipment resources has become an important subject of concern for industry. Generally, the total time required for producing a product is the sum of the times respectively required for material transport, material feeding, machining, and material output. As such, it takes a longer time to produce a product through a more complicated processing procedure. Nevertheless, a conventional machining apparatus only performs a certain one of material transport, material feeding, machining and material output for a certain product within a certain unit time, and, therefore, has limited machining efficiency.

### SUMMARY OF THE INVENTION

Therefore, an object of the present invention is to provide a machining method and apparatus that can effectively enhance machining efficiency using continuous machining.

According to one aspect of the present invention, there is provided a machining method adapted to be performed by a machining apparatus that includes a machining station, first and second material-feeding stations disposed respectively at opposite sides of the machining station in a first direction for respectively feeding a plurality of first workpieces and a plurality of second workpieces, and a slider for being mounted with target first and second workpieces respectively fed from the first and second material-feeding stations. The slider is movable in the first direction between a first position, where the slider is located between the machining station and the first material-feeding station, and a second position, where the slider is located between the machining station and the second material-feeding station. The machining method of this invention comprises the steps:

a) when the slider is moved to the first position, configuring the machining station to machine the target second workpiece on the slider, and simultaneously configuring the first material-feeding station to mount on the slider a next first workpiece as the target first workpiece; and

b) when the slider is moved to the second position, configuring the machining station to machine the target first workpiece on the slider, and simultaneously configuring the second material-feeding station to mount on the slider a next second workpiece as the target second workpiece.

According to another aspect of the present invention, a machining apparatus comprises a machine bed, a first material-feeding station, a second material-feeding station, a machining station, and at least one slider unit.

The first material-feeding station is disposed on the machine bed, and is adapted for feeding a plurality of first workpieces.

The second material-feeding station is disposed on the machine bed, is opposite to the first material-feeding station in a first direction, and is adapted for feeding a plurality of second workpieces.

The machining station is mounted on the machine bed, and is disposed spacedly between the first and second material-feeding stations. The machining station includes at least one machining unit.

The slider unit is disposed on the machine bed and includes a slider that is adapted for being mounted with target first and second workpieces respectively fed from the first and second material-feeding stations. The slider is movable in the first direction between a first position, where the slider is located between the machining station and the first material-feeding station, and a second position, where the slider is located between the machining station and the second material-feeding station.

When the slider is moved to the first position, the machining unit of the machining station is operable to machine the target second workpiece on the slider, and simultaneously, the first material-feeding station is operable to mount on the slider a next first workpiece as the target first workpiece.

When the slider is moved to the second position, the machining unit of the machining station is operable to machine the target first workpiece on the slider, and simultaneously, the second material-feeding station is operable to mount on the slider a next second workpiece as the target second workpiece.

### BRIEF DESCRIPTION OF THE DRAWINGS

Other features and advantages of the present invention will become apparent in the following detailed description of the preferred embodiment with reference to the accompanying drawings, of which:

FIGS. 1 and 2 are perspective views showing the preferred embodiment of a machining apparatus according to the present invention;

FIG. 3 is a schematic front view showing the preferred embodiment;

FIG. 4 is a partly exploded perspective view showing a machine bed, a machining station, two slider units, and first and second jig units of the preferred embodiment;

FIG. 5 is a fragmentary perspective view showing a first material-feeding station of the preferred embodiment;

FIG. 6 is a fragmentary perspective view showing a second material-feeding station of the preferred embodiment;

FIG. 7 is a schematic top view showing the preferred embodiment when a slider of each slider unit is at a first position;

FIG. 8 is a schematic top view showing the preferred embodiment when the slider of each slider unit is at a second position; and

FIG. 9 is a flow chart illustrating a machining method performed by the preferred embodiment.

### DETAILED DESCRIPTION OF THE PREFERRED EMBODIMENT

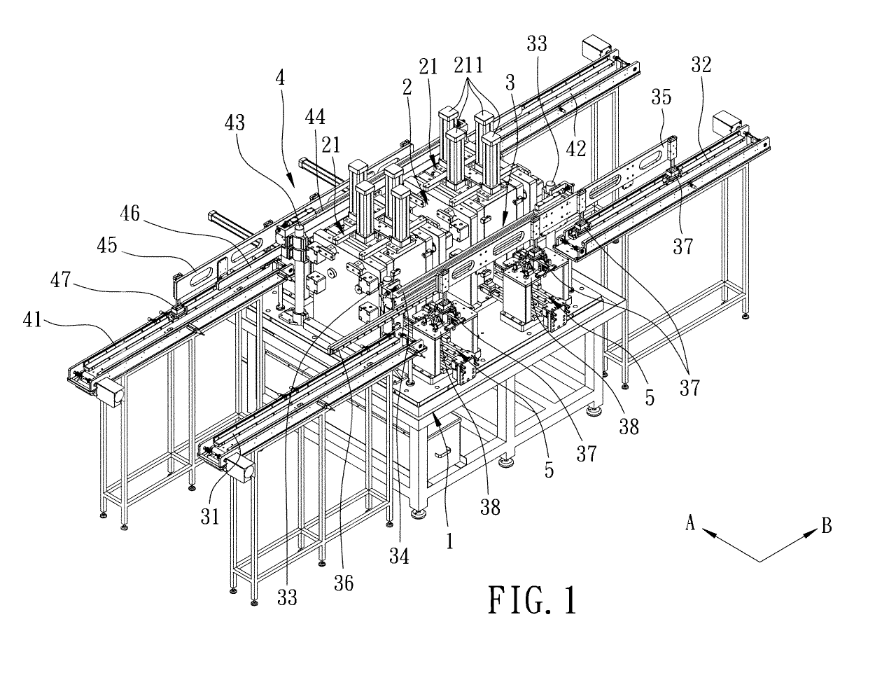

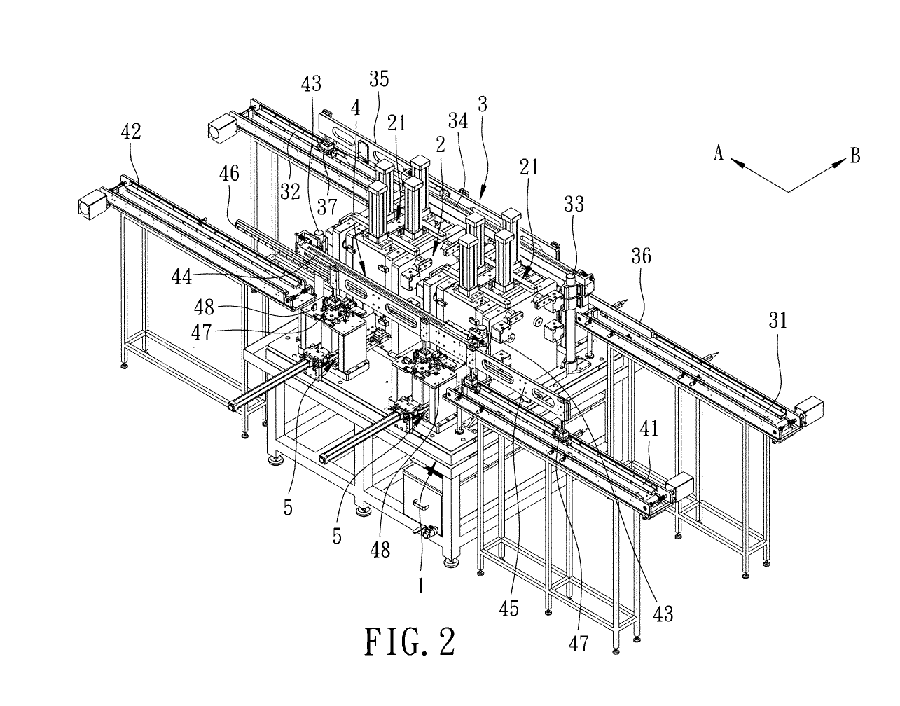

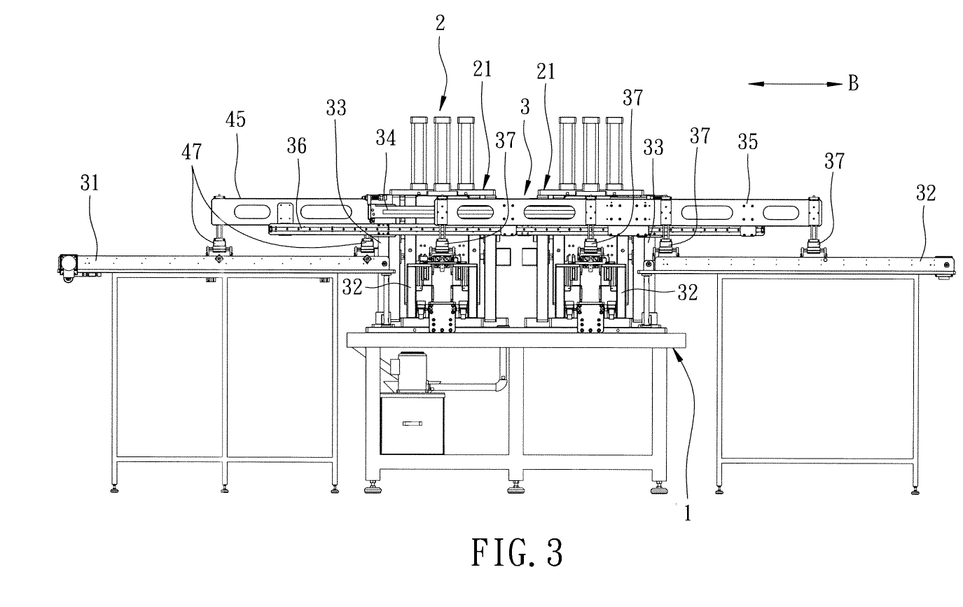

Referring to FIGS. 1 to 3, the preferred embodiment of a machining apparatus according to the present invention is shown to include a machine bed 1, a machining station 2, a first material-feeding station 3, a second material-feeding station 4, and two slider units 5.

The first material-feeding station 3 is disposed on the machine bed 1 and is adapted for feeding a plurality of first workpieces (not shown).

The second material-feeding station 4 is disposed on the machine bed 1, and is opposite to the first material-feeding station 3 in a first direction (A). The second material-feeding station 4 is adapted for feeding a plurality of second workpieces (not shown). In this embodiment, the second workpieces are identical to the first workpieces.

The machining station 2 is mounted on the machine bed 1 and is disposed spacedly between the first and second material-feeding stations 3, 4. The machining station 2 includes two machining units 21 spaced apart from each other in a second direction (B) transverse to the first direction (A). In this embodiment, each machining unit 21 has four machining heads 211, and is operable to perform pull-forming operation. In other embodiments, the machining units 21 may perform one of drilling operation, punching operation, cutting operation and cleaning operation. Since the feature of this invention does not reside in the machining units 21, which are known to those skilled in the art, details of the same are omitted herein for the sake of brevity.

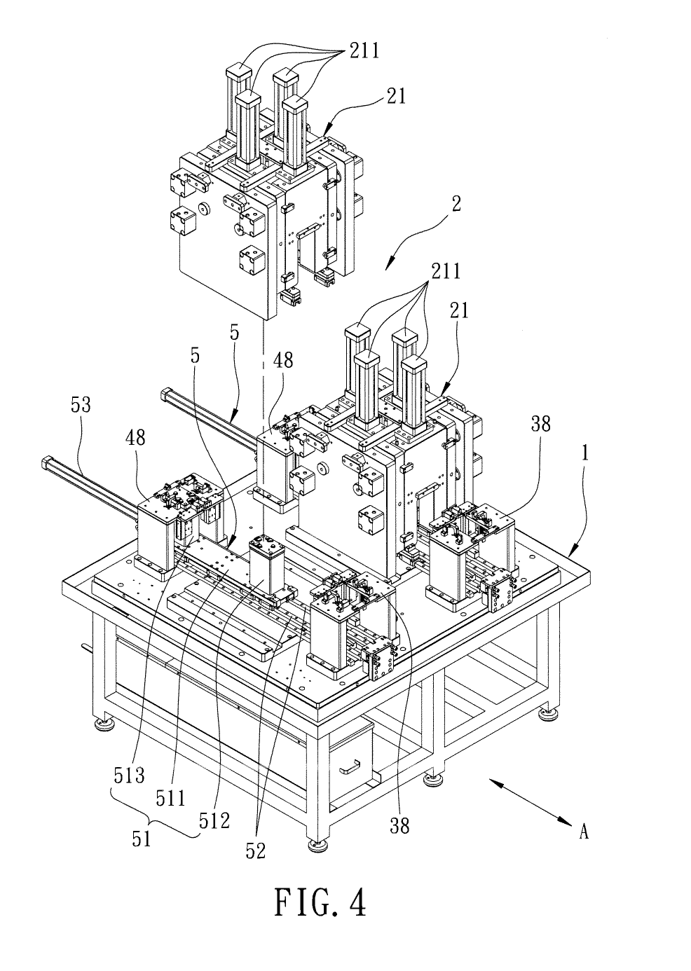

Referring further to FIG. 4, the slider units 5 are disposed on the machine bed 1, and correspond respectively to the two machining units 21. Each slider unit 5 includes a slider 51, a pair of slide rails 52, and a driving member 53.

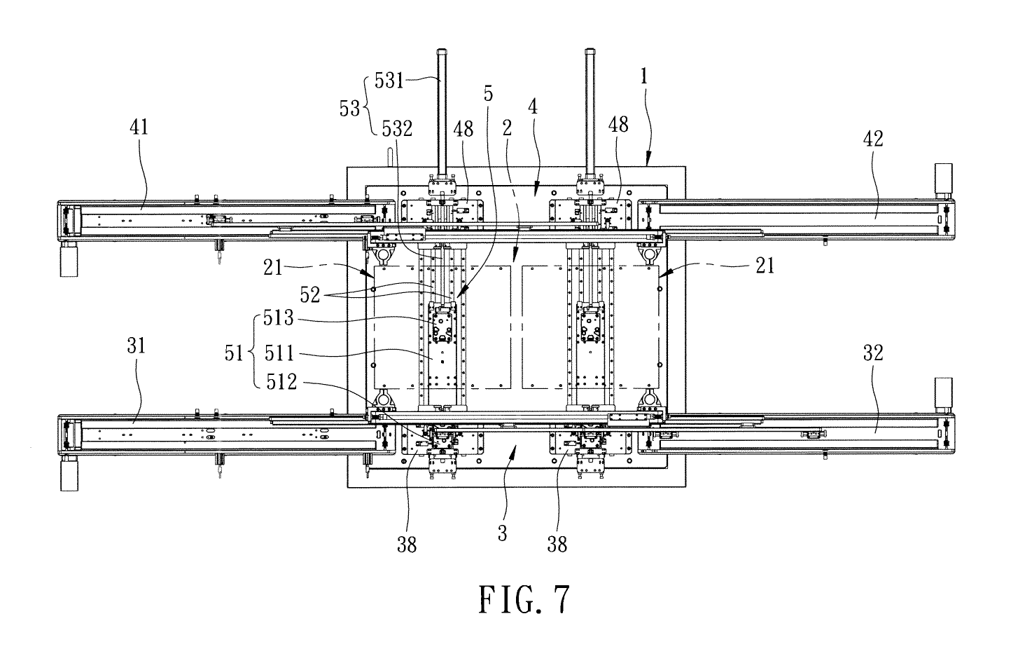

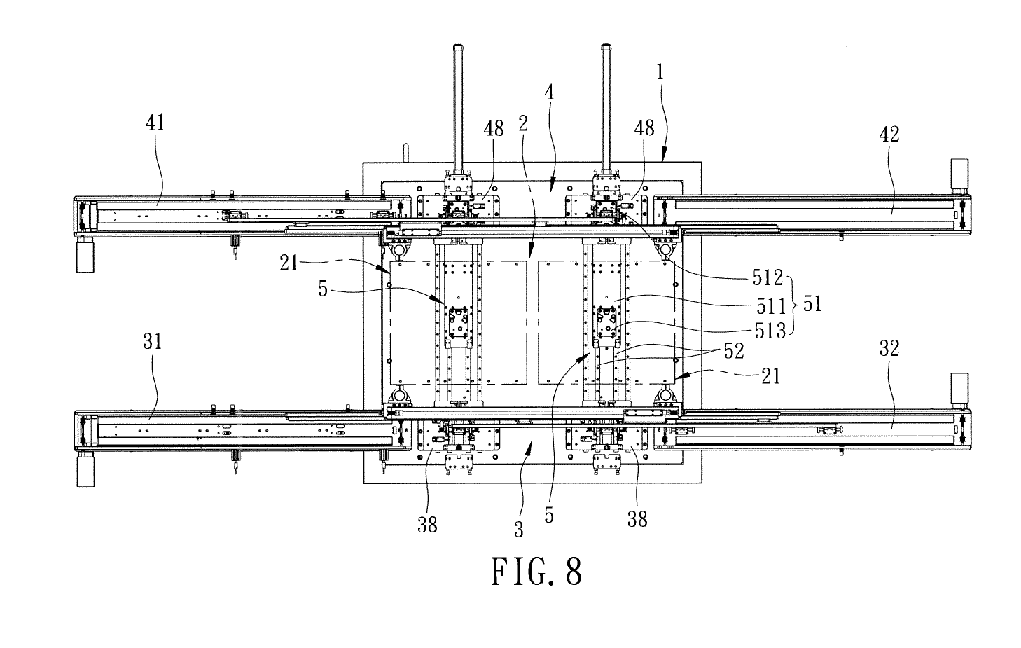

For each slider unit 5, the slide rails 52 are disposed fixedly on the machine bed 1, and extend in the first direction (A) between the first and second material-feeding stations 3, 4 through a corresponding one of the machining units 21 of the machining station 2. The slider 51 is adapted for being mounted with target first and second workpieces fed respectively from the first and second material-feeding stations 3, 4. The slider 51 is mounted movably on the slide rails 52 such that the slider 51 is slidable along the slide rails 52 in the first direction (A) between a first position (see FIG. 7), where the slider 51 is located between the machining station 2 and the first material-feeding station 3, and a second position (see FIG. 8), where the slider 51 is located between the machining station 2 and the second material-feeding station 4. In this embodiment, the slider 51 includes a slide board 511 mounted movably on the slide rails 52, and first and second workpiece-mounting seats 512, 513 disposed spacedly on the slide board 511, opposite to each other in the first direction (A), and respectively mounted with the target first and second workpieces thereon. The first and second workpiece-mounting seats 512, 513 of the slider 51 are respectively located in the first material-feeding station 3 and the corresponding machining unit 21 of the machining station 2 when the slider 51 is moved to the first position, and are respectively located in the corresponding machining unit 21 of the machining station 2 and the second material-feeding station 4 when the slider 51 is moved to the second position. The driving member 53 is disposed on the machine bed 1 for driving the slider 51 to move between the first and second positions. In this embodiment, the driving member 53 is a fluid cylinder that includes a cylinder body 531, and a piston rod 532 having one end connected movably to the cylinder body 531 and the other end connected to the slide board 511 of the slider 51, as best shown in FIG. 7.

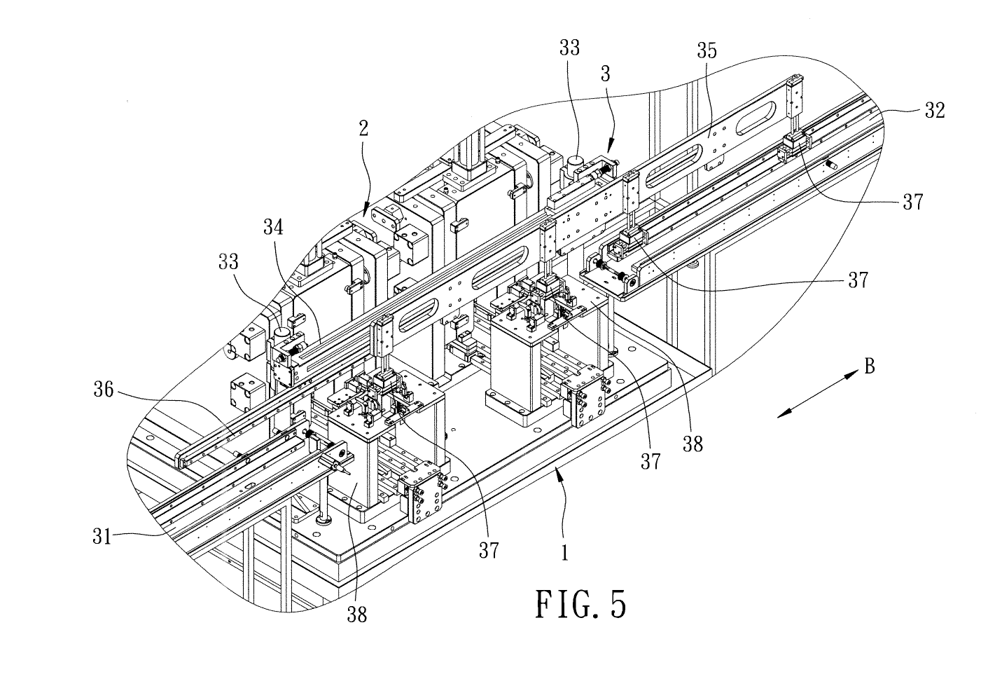

Referring further to FIG. 5, in this embodiment, the first material-feeding station 3 includes spaced apart first material-inputting and material-outputting transport belts 31, 32, a first clamping unit, and two first jig units 38.

The first material-inputting transport belt 31 extends in the second direction (B) and is adapted for transporting the first workpieces to be machined.

The first material-outputting transport belt 32 extends in the second direction (B) and is opposite to the first material-inputting transport belt 31 in the second direction (B).

The first clamping unit is disposed on the machine bed 1. In this embodiment, the first clamping unit includes a pair of first support rods 33, a first rodless cylinder 34, a first mounting plate 35, a first guide rail 36, and two pairs of first clamping jaws 37. The first support rods 33 are disposed fixedly on the machine bed 1 and are spaced apart from each other in the second direction (B). The first rodless cylinder 34 extends between and is mounted on the first support rods 33. The first mounting plate 35 extends in the second direction (B) and is connected to the first rodless cylinder 34 such that the first mounting plate 35 is driven by the first rodless cylinder 34 to move in the second direction (B). The first guide rail 36 extends in the second direction (B), is mounted on the first support rods 33, and engages movably the first mounting plate 35 for guiding movement of the first mounting plate 35 in the second direction (B). The first clamping jaws 37 are mounted on the first mounting plate 35. When the slider 51 of each slider unit 5 is moved to the first position, the first clamping jaws 37 are operable to respectively clamp two machined first workpieces on the first workpiece-mounting seats 512 of the sliders 51 of the slider units 5 and next two first workpieces on the first material-inputting transport belt 31 when the first mounting plate 35 is moved by driving of the first rodless cylinder 34 to be distal from the first material-outputting transport belt 32 and to respectively release the two machined first workpieces and the next two first workpieces onto the first material-outputting transport belt 32 and the first workpiece-mounting seats 512 of the sliders 51 of the slider units 5 when the first mounting plate 35 is moved by driving of the first rodless cylinder 34 to be distal from the first material-inputting transport belt 31.

The first jig units 38 are disposed spacedly between and are aligned with the first material-inputting and material-outputting transport belts 31, 32 in the second direction (B) for respectively receiving the first workpiece-mounting seats 512 of the sliders 51 of the slider units 5 therein when the slider 51 of each slider unit 5 is moved to the first position, as best shown in FIG. 7. Since the feature of this invention does not reside in the first jig units 38, which are known to those skilled in the art, details of the same are omitted herein for the sake of brevity.

When the slider 51 of each slider unit 5 is moved to the first position, the first clamping unit is operable to clamp the two machined first workpieces on the first workpiece-mounting seats 512 of the sliders 51 of the slider units 5 and the next two first workpieces on the first material-inputting transport belt 31 using the first clamping jaws 37 so as to move respectively the two machined first workpieces and the next two first workpieces away from the sliders 51 of the slider units 5 and the first material-inputting transport belt 31 in response to movement of the first mounting plate 35 by driving of the first rodless cylinder 34, to place respectively the two machined first workpieces and the next two first workpieces clamped by the first clamping jaws 37 on the first material-outputting transport belt 32 and the first workpiece-mounting seats 512 of the sliders 51 of the slider units 5, and to release the two machined first workpieces and the next two first workpieces from the first clamping jaws 37 such that the two machined first workpieces are moved out by the first material-outputting transport belt 32 and such that the next two first workpieces are respectively mounted on the first workpiece-mounting seats 512 of the sliders 51 of the slider units 5.

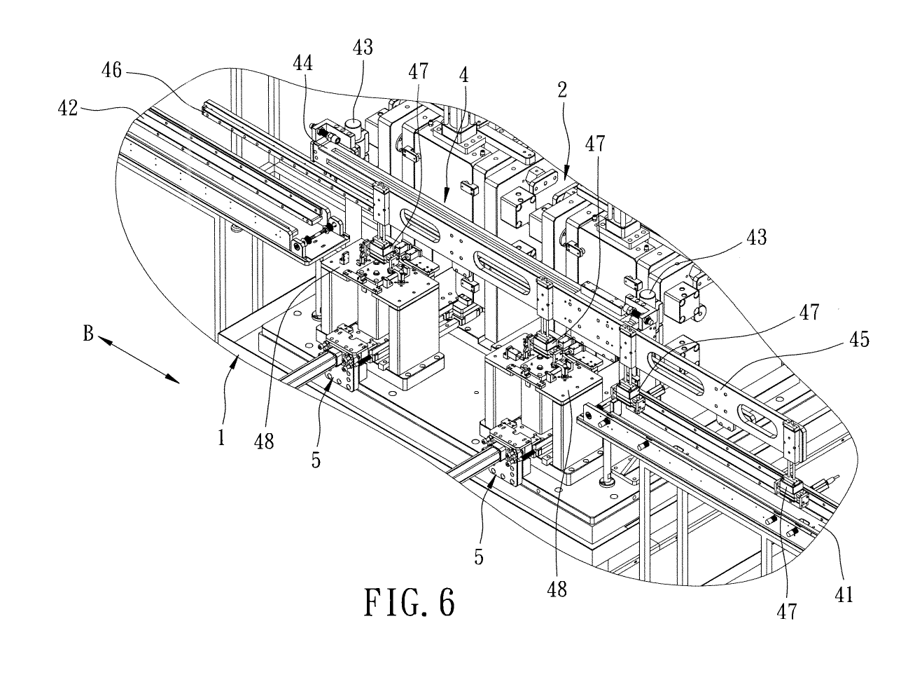

Referring further to FIG. 6, in this embodiment, the second material-feeding station 4 includes spaced apart second material-inputting and material-outputting transport belts 41, 42, a second clamping unit, and two second jig units 48.

The second material-inputting transport belt 41 extends in the second direction (B) and is adapted for transporting the second workpieces to be machined.

The second material-outputting transport belt 42 extends in the second direction (B) and is opposite to the second material-inputting transport belt 41 in the second direction (B).

The second clamping unit is disposed on the machine bed 1. In this embodiment, similar to the first clamping unit, the second clamping unit includes a pair of second support rods 43, a second rodless cylinder 44, a second mounting plate 45, a second guide rail 46, and two pairs of second clamping jaws 47. The second support rods 43 are disposed fixedly on the machine bed 1 and are spaced apart from each other in the second direction (B). The second rodless cylinder 44 extends between and is mounted on the second support rods 43. The second mounting plate 45 extends in the second direction (B) and is connected to the second rodless cylinder 44 such that the second mounting plate 45 is driven by the second rodless cylinder 44 to move in the second direction (B). The second guide rail 46 extends in the second direction (B) is mounted on the second support rods 43, and engages movably the second mounting plate 45 for guiding movement of the second mounting plate 45 in the second direction (B). The second clamping jaws 47 are mounted on the second mounting plate 45. When the slider 51 of each slider unit 5 is moved to the second position, the second clamping jaws 47 are operable to respectively clamp two machined second workpieces on the second workpiece-mounting seats 513 of the sliders 51 of the slider units 5 and next two second workpieces on the second material-inputting transport belt 41 when the second mounting plate 45 is moved by driving of the second rodless cylinder 44 to be distal from the second material-outputting transport belt 42 and to respectively release the two machined second workpieces and the next two second workpieces onto the second material-outputting transport belt 42 and the second workpiece-mounting seats 513 of the sliders 51 of the slider units 5 when the second mounting plate 45 is moved by driving of the second rodless cylinder 44 to be distal from the second material-inputting transport belt 41.

The second jig units 48 are disposed spacedly between and are aligned with the second material-inputting and material-outputting transport belts 41, 42 in the second direction (B) for respectively receiving the second workpiece-mounting seats 513 of the sliders 51 of the slider units 5 therein when the slider 51 of each slider unit 5 is moved to the first position, as best shown in FIG. 8. Since the feature of this invention does not reside in the second jig units 48, which are known to those skilled in the art, details of the same are omitted herein for the sake of brevity.

When the slider 51 of each slider unit 5 is moved to the second position, the second clamping unit is operable to clamp the two machined second workpieces on the second workpiece-mounting seats 513 of the sliders 51 of the slider units 5 and the next two second workpieces on the second material-inputting transport belt 41 using the second clamping jaws 47 so as to move respectively the two machined second workpieces and the next two second workpieces away from the sliders 51 of the slider units 5 and the second material-inputting transport belt 41 in response to movement of the second mounting plate 45 by driving of the second rodless cylinder 44, to place respectively the two machined second workpieces and the next two second workpieces clamped by the second clamping jaws 47 on the second material-outputting transport belt 42 and the second workpiece-mounting seats 513 of the sliders 51 of the slider units 5, and to release the two machined second workpieces and the next two second workpieces from the second clamping jaws 47 such that the two machined second workpieces are moved out by the second material-outputting transport belt 42 and such that the next two second workpieces are respectively mounted on the second workpiece-mounting seats 513 of the sliders 51 of the slider units 5.

In use, when the slider 51 of each slider unit 5 is driven by the driving member 53 of a corresponding slider unit 5 to move to the first position, the machining units 21 of the machining station 2 respectively machine the target second workpieces on the second workpiece-mounting seats 513 of the sliders 51 of the slider units 5, and simultaneously, the first clamping unit of the first material-feeding station 3 moves the machined first workpieces from the first workpiece-mounting seats 512 of the sliders 51 of the slider units 5 to the first material-outputting transport belt 32 and mounts on the first workpiece-mounting seats 512 of the sliders 51 of the slider units 5 the next two first workpieces fed from the first material-inputting transport belt 31 as the target first workpieces. When the slider 51 of each slider unit 5 is driven by the driving member 53 of the corresponding slider unit 5 to move to the second position, the machining units 21 of the machining station 2 respectively machine the target first workpieces on the first workpiece-mounting seats 512 of the sliders 51 of the slider units 5, and simultaneously, the second clamping unit of the second material-feeding station 4 moves the machined second workpieces from the second workpiece-mounting seats 513 of the sliders 51 of the slider units 5 to the second material-outputting transport belt 42 and mounts on the second workpiece-mounting seats 513 of the sliders 51 of the slider units 5 the next two second workpieces fed from the second material-inputting transport belt 41 as the target second workpieces.

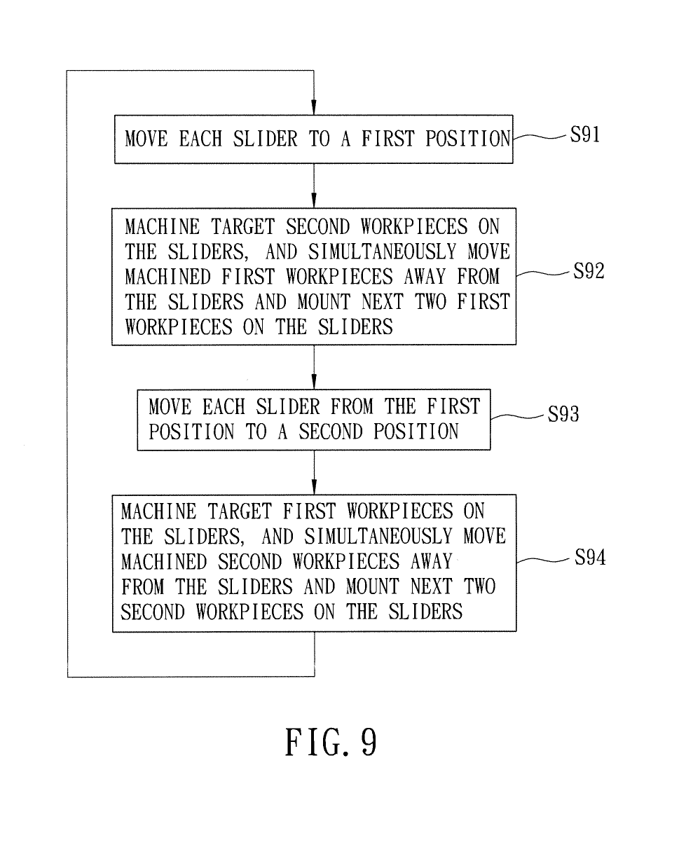

FIG. 9 is a flow chart of a machining method performed by the machining apparatus of the present invention.

In step S91, the slider 51 of each slider unit 5 is driven by the driving member 53 of the corresponding slider unit 5 to move to the first position.

In step S92, the machining units 21 of the machining station 2 respectively machine the two target second workpieces previously mounted on the second workpiece-mounting seats 513 of the sliders 51 of the slider units 5. Simultaneously, the first clamping unit moves the machined first workpieces from the first workpiece-mounting seats 512 of the sliders 51 of the slider units 5 to the first material-outputting transport belt 32 and mounts on the first workpiece-mounting seats 512 of the sliders 51 of the slider units 5 the next two first workpieces fed from the first material-inputting transport belt 31 as the target first workpieces.

In step S93, the slider 51 of each slider unit 5 is driven by the driving member 53 of the corresponding slider unit 5 to move from the first position to the second position.

In step S94, the machining units 21 of the machining station 2 respectively machine the two target first workpieces mounted on the first workpiece-mounting seats 512 of the sliders 51 of the slider units 5 in step S92. Simultaneously, the second clamping unit moves the second workpieces machined in step S92 from the second workpiece-mounting seats 513 of the sliders 51 of the slider units 5 to the second material-outputting transport belt 42 and mounts on the second workpiece-mounting seats 513 of the sliders 51 of the slider units 5 the next two second workpieces fed from the second material-inputting transport belt 41 as the target second workpieces. Then, the flow goes back to step S91.

It is noted that the numbers of the slider units 5, the machining units 21, the first jig units 38 and the second jig units 48 are equal to two in this embodiment, but are not limited thereto.

In such a configuration, since the sliders 51 can repeatedly move in the first direction (A) between the first and second positions so as to alternately transport the target first workpieces and the target second workpieces to the machining station 2, the machining station 2 can continuously and alternately machine the target first workpieces and the target second workpieces. Furthermore, during machining of the target first workpieces, the next two second workpieces as the target second workpieces to be machined are respectively mounted on the sliders 51 of the slider units 5. Alternatively, during machining of the target second workpieces, the next two first workpieces as the target first workpieces to be machined are respectively mounted on the sliders 51 of the slider units 5. As such, for the machining station 2, the waiting time for moving the machined first/second workpieces away from the sliders 51 of the slider units 5 and for mounting the target first/second workpieces on the sliders 51 of the slider units 5 can be saved. Therefore, the machining efficiency of the machining apparatus of the present invention can be effectively enhanced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A machining method adapted to be performed by a machining apparatus that includes a machining station, first and second material-feeding stations disposed respectively at opposite sides of the machining station in a first direction for respectively feeding a plurality of first workpieces and a plurality of second workpieces, and a slider for being mounted with target first and second workpieces respectively fed from the first and second material-feeding stations, the slider being movable in the first direction between a first position, where the slider is located between the machining station and the first material-feeding station, and a second position, where the slider is located between the machining station and the second material-feeding station, said machining method comprising the steps:
a) when the slider is moved to the first position, configuring the machining station to machine the target second workpiece on the slider, and simultaneously configuring the first material-feeding station to mount on the slider a next first workpiece as the target first workpiece; and
b) when the slider is moved to the second position, configuring the machining station to machine the target first workpiece on the slider, and simultaneously configuring the second material-feeding station to mount on the slider a next second workpiece as the target second workpiece.

2. The machining method as claimed in claim 1, wherein:
in step a), prior to mounting the next first workpiece on the slider, a machined first workpiece is moved away from the slider; and
in step b), prior to mounting the next second workpiece on the slider, a machined second workpiece is moved away from the slider.

3. A machining apparatus comprising:
a machine bed;
a first material-feeding station disposed on said machine bed and adapted for feeding a plurality of first workpieces;
a second material-feeding station disposed on said machine bed, opposite to said first material-feeding station in a first direction, and adapted for feeding a plurality of second workpieces;
a machining station mounted on said machine bed and disposed spacedly between said first and second material-feeding stations, said machining station including at least one machining unit; and
at least one slider unit disposed on said machine bed and including a slider that is adapted for being mounted with target first and second workpieces respectively fed from said first and second material-feeding stations, said slider being movable in the first direction between a first position, where said slider is located between said machining station and said first material-feeding station, and a second position, where said slider is located between said machining station and said second material-feeding station;
wherein, when said slider is moved to the first position, said machining unit of said machining station is operable to machine the target second workpiece on said slider, and simultaneously, said first material-feeding station is operable to mount on said slider a next first workpiece as the target first workpiece; and
wherein, when said slider is moved to the second position, said machining unit of said machining station is operable to machine the target first workpiece on said slider, and simultaneously, said second material-feeding station is operable to mount on said slider a next second workpiece as the target second workpiece.

4. The machining apparatus as claimed in claim 3, wherein:
said first material-feeding station includes
spaced apart first material-inputting and material-outputting transport belts extending and opposite to each other in a second direction transverse to the first direction, said first material-inputting transport belt being adapted for transporting the first workpieces to be machined, and
a first clamping unit disposed on said machine bed, when said slider is moved to the first position, said first clamping unit being operable to clamp a machined first workpiece on said slider and the next first workpiece on said first material-inputting transport belt so as to move the machined first workpiece and the next first workpiece respectively away from said slider and said first material-inputting transport belt, and to release the machined first workpiece and the next first workpiece respectively on said first material-outputting transport belt and said slider; and
said second material-feeding station includes
spaced apart second material-inputting and material-outputting transport belts extending and opposite to each other in the second direction, said second material-inputting transport belt being adapted for transporting the second workpieces to be machined, and
a second clamping unit disposed on said machine bed, when said slider is moved to the second position, said second clamping unit being operable to clamp a machined second workpiece on said slider and the next second workpiece on said second material-inputting transport belt so as to move the machined second workpiece and the next second workpiece respectively away from said slider and said second material-inputting transport belt, and to release the machined second workpiece and the next second workpiece respectively on said second material-outputting transport belt and said slider.

5. The machining apparatus as claimed in claim 4, wherein:
said first clamping unit of said first material-feeding station includes
a pair of first support rods disposed fixedly on said machine bed and spaced apart from each other in the second direction,
a first rodless cylinder extending between and mounted on said first support rods,
a first mounting plate extending in the second direction and connected to said first rodless cylinder such that said first mounting plate is driven by said first rodless cylinder to move in the second direction,
a first guide rail extending in the second direction, mounted on said first support rods, and engaging movably said first mounting plate for guiding movement of said first mounting plate in the second direction, and
at least one pair of first clamping jaws mounted on said first mounting plate, when said slider is moved to the first position, said first clamping jaws being operable to clamp respectively the machined first workpiece on said slider and the next first workpiece on said first material-inputting transport belt when said first mounting plate is moved by driving of said first rodless cylinder to be distal from said first material-outputting transport belt and to respectively release the machined first workpiece and the next first workpiece onto said first material-outputting transport belt and said slider when said first mounting plate is moved by driving of said first rodless cylinder to be distal from said first material-inputting transport belt; and
said second clamping unit of said second material-feeding station includes
a pair of second support rods disposed fixedly on said machine bed and spaced apart from each other in the second direction,
a second rodless cylinder extending between and mounted on said second support rods,
a second mounting plate extending in the second direction and connected to said second rodless cylinder such that said second mounting plate is driven by said second rodless cylinder to move in the second direction,
a second guide rail extending in the second direction, mounted on said second support rods, and engaging movably said second mounting plate for guiding movement of said second mounting plate in the second direction, and
at least one pair of second clamping jaws mounted on said second mounting plate, when said slider is moved to the second position, said second clamping jaws being operable to clamp respectively the machined second workpiece on said slider and the next second workpiece on said second material-inputting transport belt when said second mounting plate is moved by driving of said second rodless cylinder to be distal from said second material-outputting transport belt and to respectively release the machined second workpiece and the next second workpiece onto said second material-outputting transport belt and said slider when said second mounting plate is moved by driving of said second rodless cylinder to be distal from said second material-inputting transport belt.

6. The machining apparatus as claimed in claim 5, wherein said slider unit further includes:
a pair of slide rails disposed fixedly on said machine bed, and extending in the first direction between said first and second material-feeding stations through said machining unit of said machining station, said slider being mounted movably on said slide rails such that said slider is slidable along said slide rails between the first and second positions; and
a driving member disposed on said machine bed for driving said slider to move between the first and second positions.

7. The machining apparatus as claimed in claim 6, wherein said slider of said slider unit includes a slide board mounted movably on said slide rails, and first and second workpiece-mounting seats disposed spacedly on said slide board, opposite to each other in the first direction, and respectively mounted with the target first and second workpieces thereon, said first and second workpiece-mounting seats being respectively located in said first material-feeding station and said machining unit of said machining station when said slider is moved to the first position, and being respectively located in said machining unit of said machining station and said second material-feeding station when said slider is moved to the second position.

8. The machining apparatus as claimed in claim 7, wherein:
said first material-feeding station further includes at least one first jig unit disposed spacedly between and aligned with said first material-inputting and material-outputting transport belts in the second direction for receiving said first workpiece-mounting seat of said slider therein when said slider is moved to the first position; and
said second material-feeding station further includes at least one second jig unit disposed spacedly between and aligned with said second material-inputting and material-outputting transport belts in the second direction for receiving said second workpiece-mounting seat of said slider therein when said slider is moved to the second position.
